(19) United States
(12) Patent Application Publication
(10) Pub. No.: US 2016/0098329 A1
(43) Pub. Date: Apr. 7, 2016

(54) INFORMATION PROCESSING TECHNIQUE FOR UNINTERRUPTIBLE POWER SUPPLY

(71) Applicant: FUJITSU LIMITED, Kawasaki-shi (JP)

(72) Inventor: Mikio UEHARA, Kawasaki (JP)

(73) Assignee: FUJITSU LIMITED, Kawasaki-shi (JP)

(21) Appl. No.: 14/966,887

(22) Filed: Dec. 11, 2015

Related U.S. Application Data
(63) Continuation of application No. PCT/JP2013/069057, filed on Jul. 11, 2013.

(51) Int. Cl. G06F 11/20

(52) U.S. Cl. CPC G06F 11/2015; G06F 2201/805

(57) ABSTRACT

This information processing apparatus includes a display processing unit to perform, on a display device, display for requesting a user to collectively input, for each of plural apparatuses whose activation or stop is to be controlled, a first time for causing a power-supply start to be delayed since a power feeding start or a second time for causing a power-supply stop to be delayed since a power failure, by an uninterruptible power supply that supplies power to the apparatus among one or more uninterruptible power supplies or by a power feeding management group in the uninterruptible power supply; and a setting unit to set, for each of the plural apparatuses, the inputted first time or second time for the uninterruptible power supply that supplies power to the apparatus, via a communication network.

### CROSS-REFERENCE TO RELATED APPLICATIONS

This application is a continuation application, filed under 35 U.S.C. section 111(a), of International Application PCT/JP2013/069057, filed on Jul. 11, 2013, the entire contents of which are incorporated herein by reference.

### FIELD

This invention relates to a technique for performing settings for an uninterruptible power supply.

### BACKGROUND

There is a technique for performing settings for the Uninterruptible Power Supply (UPS) from a Web browser of a personal computer (PC) connected to a Local Area Network (LAN), when a LAN interface and a Web server function are provided for the UPS. However, this technique merely illustrates an example in which one UPS supplies the power for one PC.

In addition, there is another technique using such a technique as follows. In other words, plural first interfaces that communicate information among plural uninterruptible power supplies, a second interface that communicates information between a specific peripheral device and a specific uninterruptible power supply and a third interface that connects via a LAN with plural uninterruptible power supplies are provided. Then, when the system power-up is made, an uninterruptible power supply that is connected with a server instructs the power-up of the specific peripheral device to an uninterruptible power supply for the specific peripheral device through the first or third interface. After that, in response to power-up completion signals of plural peripheral devices, the uninterruptible power supply for the specific peripheral device instructs the power-up of the server to an uninterruptible power supply for the server. This technique realizes the linkage of the uninterruptible power supplies by also using connections other than the LAN. Moreover, although plural devices are appropriately activated by the linkage of the plural uninterruptible power supplies, the settings for the uninterruptible power supplies are complicated.

Moreover, in such a conventional technique, the possibility becomes high that an erroneous setting or inconsistent setting among the uninterruptible power supplies is made, because a setting for a device to which the uninterruptible power supply supplies the power is individually made for each uninterruptible power supply.

Patent Document 1: Japanese Laid-open Patent Publication No. 2000-78224

Patent Document 2: Japanese Laid-open Patent Publication No. 2004-30213

Therefore, there is no conventional technique for enabling to efficiently perform settings for the uninterruptible power supplies.

### SUMMARY

An information processing apparatus relating to one aspect of this invention includes (A) a display processing unit to perform, on a display device, display for requesting a user to collectively input, for each of plural apparatuses whose activation or stop is to be controlled, a first time for causing a power-supply start to be delayed since a power feeding start or a second time for causing a power-supply stop to be delayed since a power failure, by an uninterruptible power supply that supplies power to the apparatus among one or more uninterruptible power supplies or by a power feeding management group in the uninterruptible power supply; and (B) a setting unit to set, for each of the plural apparatuses, the inputted first time or second time for the uninterruptible power supply that supplies power to the apparatus, via a communication network.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram depicting an entire system configuration relating to a first embodiment;

FIG. 2 is a diagram depicting a power-up sequence and a power-down sequence of the system;

FIG. 3 is a functional block diagram of a management console;

FIG. 4 is a diagram an outline of a processing flow relating to the embodiment;

FIG. 5 is a diagram depicting a processing flow of setting processing;

FIG. 6 is a diagram depicting an example of a setting screen;

FIG. 7 is a diagram depicting an example of setting data stored in a data storage unit;

FIG. 8 is a diagram depicting an operation sequence;

FIG. 9 is a diagram depicting a processing flow of operation confirmation processing;

FIG. 10 is a diagram depicting an entire system configuration relating to a second embodiment;

FIG. 11 is a diagram depicting an example of a setting screen relating to the second embodiment;

FIG. 12 is a diagram depicting an example of a setting screen relating to other embodiments;

FIG. 13A is a diagram depicting an example of a setting screen relating to other embodiments;

FIG. 13B is a diagram depicting an example of a setting screen relating to other embodiments; and

FIG. 14 is a functional block diagram of a computer.

### DESCRIPTION OF EMBODIMENTS

### Embodiment 1

In this embodiment, a case is considered in which plural uninterruptible power supplies are applied to a system that mainly includes a server, a storage device and network apparatuses such as hubs and switches. However, apparatuses such as the server may be changed according to a system configuration. In addition, activation order, stop order and their intervals are appropriately changed according to the configuration.

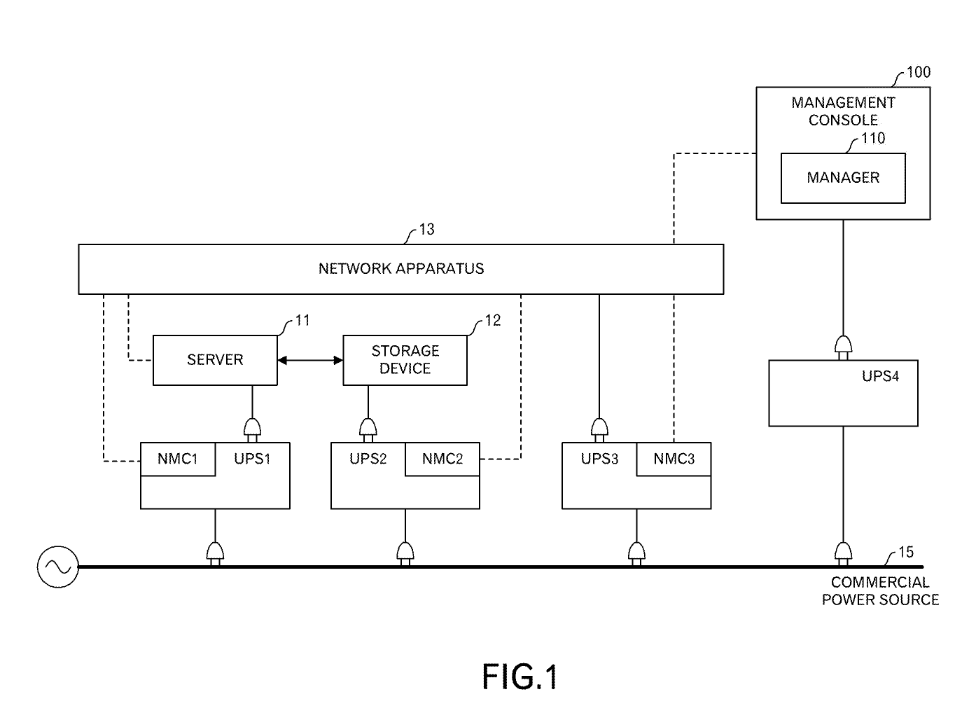

For example, a system as illustrated in FIG. 1 is assumed. A server 11 is connected with a UPS1 through a power-supply cable, a storage device 12 is connected with a UPS2 through a power-supply cable, and a network apparatus 13 is connected with a UPS3 through a power-supply cable. Furthermore, a management console 100 that is a personal computer or the like is also connected with a UPS4 through a power-supply cable.

The UPS1 has an NMC1 (Network Management Card), and is connected with the network apparatus 13 by the NMC1 through a network cable. The UPS2 has an NMC2, and is connected with the network apparatus 13 by the NMC2 through a network cable. Similarly, the UPS3 has an NMC3, and is connected with the network apparatus 13 by the NMC3 through a network cable. The UPS4 is an option, and may have an NMC or may not have any NMC. The UPS1 to UPS4 are connected with the commercial power source 15 with a power-supply cable. The UPS1 to UPS4 have functions of the conventional UPS. Specifically, the UPS begins the power supply to a connected apparatus at a preset timing since the beginning of the power feeding from the commercial power source 15, and stops the power supply to the connected apparatus at a preset timing since an occurrence of the power failure of the commercial power source 15. In addition, because the UPS has the NMC, it is possible to receive and set setting data for a predetermined apparatus through the network, and notify state changes.

Furthermore, the management console 100 is also connected with the network apparatus 13 by a network cable. Moreover, the management console 100 has a manager 110, which is realized by executing a management program.

Thus, the UPS1 to UPS3 (specifically, NMC1 to NMC3), the management console 100 and the server 11 are connected with a LAN that includes the network apparatus 13.

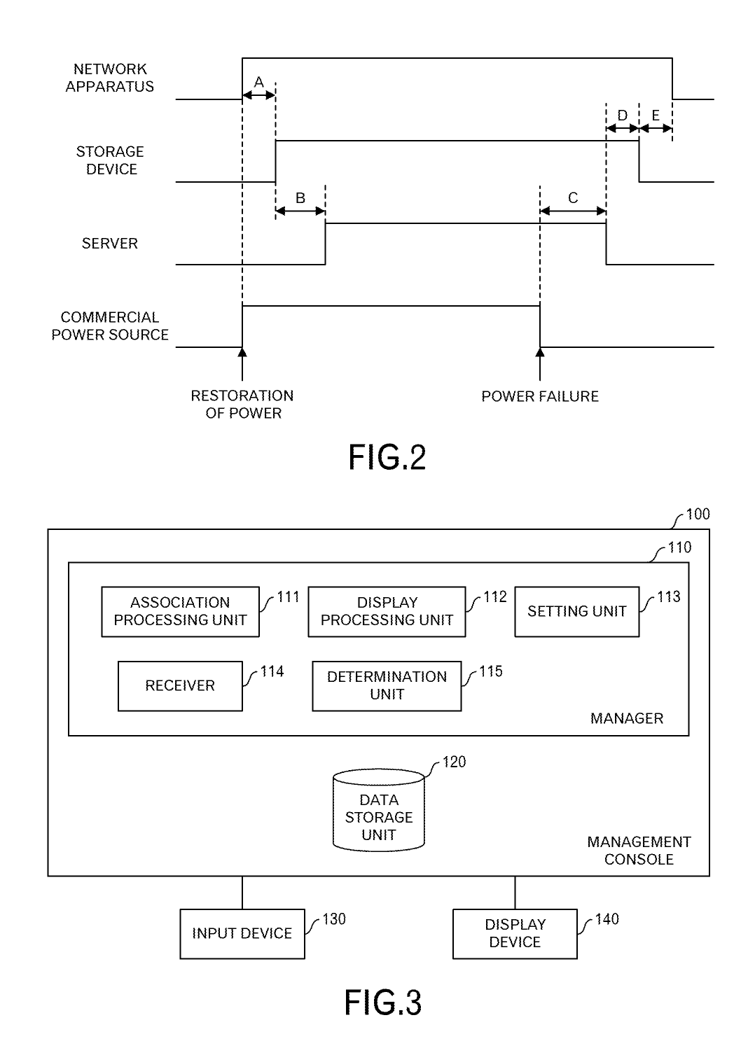

In this embodiment, assume that a power-up sequence and a power-down sequence as illustrated in FIG. 2 are realized. In other words, at the power restoration timing when the power feeding of the commercial power source 15 restored, the power-up to the network apparatus 13 is performed, and then, the power-up to the storage device 12 is performed, and finally, the power-up to the server 11 is performed. A period A from the power-up to the network apparatus 13 to the power-up to the storage device 12 corresponds to a time during the activation of the network apparatus 13 and its margin. A period B from the power-up to the storage device 12 to the power-up to the server 11 corresponds to a time during the activation of the storage device 12 and its margin.

On the other hand, at the timing when the power failure occurred, the shut-down of the server 11 begins, and after the shut-down is completed, the power-supply to the server 11 is stopped, and then, the power-supply to the storage device 12 is stopped, and finally, the power-supply to the network apparatus 13 is stopped. A period C from the power failure timing to the stop of the power-supply to the server 11 corresponds to a time for shut-down processing of the server 11 and its margin. In addition, a period D from the stop of the power-supply to the server 11 to the stop of the power-supply to the storage device 12 and a period E from the stop of the power-supply to the storage device 12 to the stop of the power-supply to the network apparatus 13 respectively correspond to predetermined grace periods.

In order to perform operations of the aforementioned activation and stop, the management console 100 has a configuration as illustrated in FIG. 3.

In other words, the management console 100 has the manager 110 and a data storage unit 120. Moreover, an input device 130 such as a mouse or a keyboard and a display device 140 are connected with the management console 100. Furthermore, the manager 110 has an association processing unit 111, a display processing unit 112, a setting unit 113, a receiver 114 and a determination unit 115.

The association processing unit 111 associates the UPS with an apparatus connected with the UPS by the power-supply cable, in response to an instruction from a user, for example.

The display processing unit 112 causes the display device 140 to perform display to collectively set the power-supply start timings and the power-supply stop timings at the power feeding start and at the power failure for each apparatus connected to the UPS.

The setting unit 113 stores the setting data in the data storage unit 120, and sets the setting data to the UPS1 to UPS3 through the network apparatus 13. At this time, the setting is performed by using the Set command in Simple Network Management Protocol (SNMP) or the like.

In addition, the receiver 114 receives notification of the state change from each UPS when the operation is confirmed. For this notification of the state change, TRAP of SNMP or the like is used.

The determination unit 115 compares the power-up pattern or power-down pattern, which is identified from the setting data stored in the data storage unit 120, with the power-up pattern or power-down pattern, which is identified from the notifications of the state changes, which are received by the receiver 114, to display a result of the operation confirmation, which is a comparison result, to the display device 140.

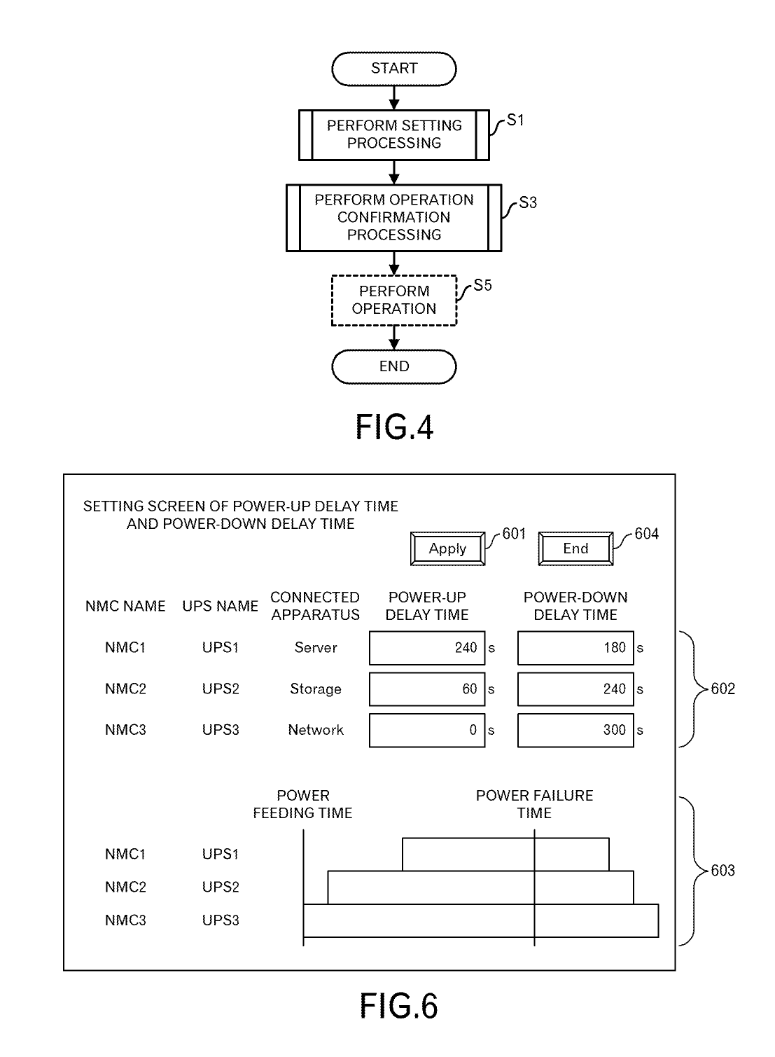

Next, details of the processing relating to this embodiment will be explained by using FIGS. 4 to 9. Firstly, an outline of the processing flow will be explained by using FIG. 4.

The manager 110 of the management console 100 performs setting processing for the UPSs, in a state where the UPSs and respective apparatuses are activated after the physical connections between the UPSs and the respective apparatuses are completed (step S1). The setting processing will be explained in detail later.

Next, in order to confirm whether or not the setting for the UPSs was appropriately performed by the setting processing, the manager 110 performs operation confirmation processing (step S3). For example, the power feeding of the commercial power source 15 is manually stopped, and furthermore the power feeding is started. The turns maybe reversed. The operation confirmation processing will be explained in detail later.

When there is a problem as a result of the operation confirmation, the setting processing is performed again, however, when there is no problem, a normal operation is performed (step S5). The normal operation does not relate to portions relating to this embodiment in the manager 110 of the management console 100. Therefore, the management console 100 may be activated or may not be activated in the normal operation. In the normal operation, the UPS operates according to the setting.

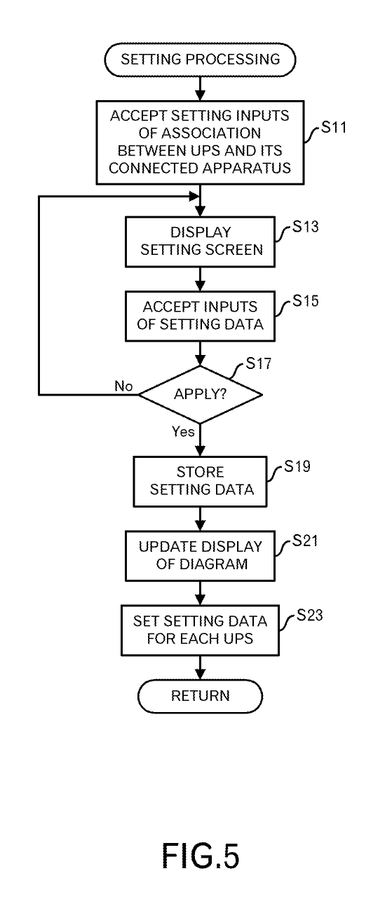

Next, the setting processing will be explained by using FIGS. 5 to 8.

When the setting for the UPSs is performed, the user causes the management console 100 to execute a management program in order to activate the manager 110. Then, the association processing unit 111 of the manager 110 causes the display device 140 to perform display for associating the UPS to be set with a connected apparatus, which is connected with that UPS by the power-supply cable, and prompts the user to input a setting for associating the UPS with the connected apparatus (FIG. 5: step S11).

In the example of FIG. 1, the UPS1 is associated with the server 11, the UPS2 is associated with the storage device 12, and the UPS3 is associated with the network apparatus 13. An address (e.g. IP address or MAC address) of the NMC1 implemented in the UPS1, an address of the NMC2 implemented in the UPS2, and an address of the NMC3 implemented in the UPS3 are obtained together. Moreover, apparatuses connected with the network apparatus 13 may be automatically detected to use them for the associations. In other words, candidates may be presented for the user to cause the user to select any candidate. In addition, the results of the automatic detection may be used for obtaining the addresses. Furthermore, the associations between NMCs and UPSs may be explicitly caused to be set.

Next, based on the association data accepted by the association processing unit 111, the display processing unit 112 causes the display device 140 to display a setting screen to collectively set the power-supply start timing and the power-supply stop timing at the power feeding start and at the power failure for each apparatus for which the association was performed (step S13).

For example, FIG. 6 illustrates an example of the setting screen. In the example of FIG. 6, the setting screen includes an Apply button 601 to reflect inputted settings to the UPSs, an End button 604, input columns 602 of a power-up delay time and a power-down delay time for defining the power-supply start timing and the power-supply stop timing, and a diagram 603 that schematically represents a power-supply time of each UPS, which is identified based on the power-up delay time and the power-down delay time that were inputted in the input columns 602.

The input columns 602 are input columns for inputting the power-up delay time and the power-down delay time for each association between the UPS and the connected apparatus (each line in FIG. 6). Thus, in this embodiment, for the associations between the UPS and the connected apparatus, numeric values can be inputted collectively. By this configuration, it becomes possible to input appropriate numeric values while seeing relations with other associations. In the example of FIG. 6, the power supply to the network apparatus 13 (Network) begins simultaneously with the power feeding start (the power-up delay time is “0” second) from the UPS3 in which the NMC3 is implemented, and the power supply to the storage device 12 (Storage) after 60 seconds (the power-up delay time is “60” seconds) since the power feeding start from the UPS2 in which the NMC2 is implemented. Finally, the power supply to the server 11 (Server) begins after 240 seconds (the power-up delay time is “240” seconds) since the power feeding start from the UPS1 in which the NMC1 is implemented. Thus, order of the power supply start and the delay times can easily be inputted and confirmed.

Similarly, in the example of FIG. 6, the UPS1 stops the power supply to the server 11 after 180 seconds (the power-down delay time is “180” seconds) since the power failure time, the UPS2 stops the power supply to the storage device 12 after 240 seconds (the power-down delay time is “240” seconds) since the power failure time, and the UPS3 stops the power supply to the network apparatus 13 after 300 seconds (the power-down delay time is “300” seconds) since the power failure time. Thus, order of the power-supply stop and the delay times can easily be inputted and confirmed.

Furthermore, based on the setting data inputted in the input columns 602, more specifically in response to a click of the Apply button 601, the diagram 603 is updated. From this diagram 603, it is possible to confirm the relation between the power feeding time and the power-supply start timing for each UPS (each connected apparatus connected to the UPS) and among the UPSs (i.e. among connected apparatuses), and to easily confirm whether or not the appropriate settings are made.

Similarly, the relationship between the power failure time and the power-supply stop timing can be confirmed for each UPS (i.e. each connected apparatus) and among the UPSs (i.e. among connected apparatuses), and it is possible to easily confirm whether or not appropriate settings are made. The power supply period can be understood by the length (the length of a horizontal bar) from the power-supply start timing to the power-supply stop timing.

Returning to the explanation of the processing in FIG. 5, the setting unit 113 of the manager 110 accepts the inputs of the setting data for the setting screen from the user, and stores the input data in a storage device such as a main memory (step S15). Then, the setting unit 113 determines whether or not the Apply button 601 was clicked by the user (step S17). When the Apply button 601 is not clicked, the processing returns to the step S13, for example, without shifting to the subsequent processing.

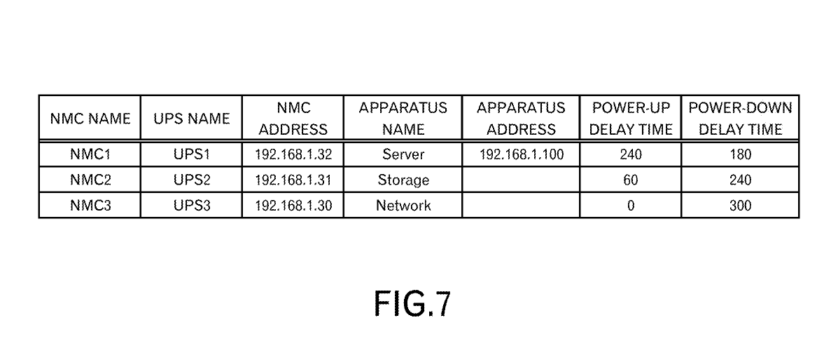

On the other hand, when the Apply button 601 was clicked and it is determined that the application of the setting data to the UPSs was instructed, the setting unit 113 stores the inputted setting data in the data storage unit 120 (step S19). For example, data as illustrated in FIG. 7 is stored in the data storage unit 120. In an example of FIG. 7, an NMC name, a UPS name, an NMC address (a UPS address), an apparatus name of the connected apparatus, an apparatus address, a power-up delay time and a power-down delay time are stored.

Furthermore, the display processing unit 112 updates the display contents in the diagram 603 according to the setting data, and causes the display device 140 to display the updated display screen (step S21). The length of the horizontal bar illustrated in the diagram 603 in the lower stage of the setting screen lengthens and shortens.

Furthermore, the setting unit 113 sets the setting data for each UPS through the LAN (step S23). For example, by using the Set command of SNMP, the power-up delay time and the power-down delay time are set for the NMC in each UPS. By doing so, the UPS operates based on this setting as usual.

When the aforementioned processing is performed, it is possible to collectively set the power-supply start timing and the power-supply stop timing for each association between the UPS and the connected apparatus while comparing and confirming them. When the setting is individually performed for each UPS, a lot of workloads are required, and the possibility becomes high that incorrect settings are made because it is difficult to compare and confirm the setting data among the UPSs. By collectively performing the settings like this embodiment, it becomes possible to easily compare and confirm the setting data, and not only the work efficiency is improved but also the possibility becomes low that incorrect setting is made.

The step S11 represents processing when no setting data is stored in the data storage unit 120, however, when the setting data has already been stored in the data storage unit 120, the display processing unit 112 may read out that setting data from the data storage unit 120, and may generate the display screen as illustrated in FIG. 6.

When the End button 604 is clicked, the processing ends. Even when the Apply button 601 was clicked, the setting data may be inputted again and the Apply button 601 may be clicked again.

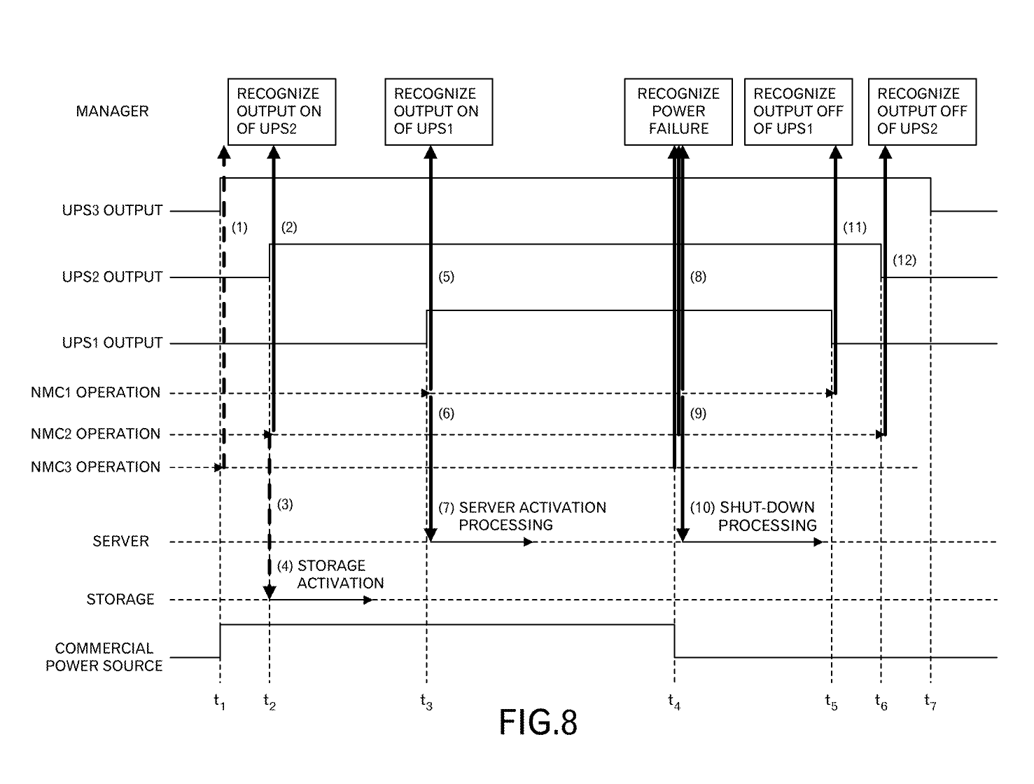

For example, when data as illustrated in FIGS. 6 and 7 is set, operations as illustrated in FIG. 8 are performed, for example.

In an example of FIG. 8, when the power feeding from the commercial power source 15 begins at time t₁, the UPS1 to UPS3 detect the beginning of the power feeding. Then, the UPS3 begins the power supply, immediately. The NMC3 of the UPS3 tries to notify the manager 110 in the management console 100 of the state change that represents the power-supply start of the UPS3 by TRAP of SNMP (step (1)), however, the notification does not reach the manager 110 when the notification is performed immediately after the activation of the network apparatus 13.

At time t₂ after 60 seconds since the time t₁, the UPS2 begins the power supply (step (3)). Then, the storage device 12 is activated (step (4)) The activation of the storage device 12 requires a longer time than the time for the activation of the network apparatus 13. The NMC2 of the UPS2 notifies the manager 110 in the management console 100 of the state change that represents the power-supply start of the UPS2 by TRAP of SNMP (step (2)). Thus, when the management console 100 is already activated, the manager 110 recognizes the power-supply start (output ON) of the UPS2.

Furthermore, at time t₃ after 180 seconds since the time t₂, the UPS1 starts the power supply. In addition, the NMC1 of the UPS1 outputs an activation instruction to the server 11 through the network apparatus 13, for example, according to the well-known Wake up On LAN technology, or the server 11 may automatically boot up according to the setting so as to automatically power up from the output ON of the UPS1 (step (6)). Then, the server 11 performs server activation processing (step (7)). Moreover, the NMC1 of the UPS1 notifies the manager 110 in the management console 100 of the state change that represents the power-supply start of the UPS1 by TRAP of SNMP through the network apparatus 13 (step (5)). According to this operation, when the management console 100 is already activated, the manager 110 recognizes the power supply start (output ON) of the UPS1.

When such operations are performed, the activation of each apparatus is appropriately performed in appropriate order.

Moreover, it is possible to grasp order that the UPS1 begins the power supply next to the UPS2 on the management console 100 side. Therefore, it is possible to determine whether or not this order is appropriate. Furthermore, it is possible to grasp the interval between the time t₂ and the time t₃ on the management console 100 side. Therefore, it is also possible to determine whether or not this interval is appropriate.

On the other hand, when the power failure occurred at time t₄, the UPS1 to UPS3 continue the power supply to the connected apparatuses by supplying the power from batteries, however, the NMC1 to NMC3 notify the occurrence of the power failure by TRAP of SNMP (step (8)).

Then, the NMC1 of the UPS1 immediately instructs the server 11 to shut down through the network apparatus 13 (step (9)). The instruction of the shut-down is performed by information notification between a UPS management software that is normally operating on the server and the NMC1. Then, the server 11 performs the shut-down processing according to the instruction of the shut-down (step (10)).

The shut-down processing of the server 11 is completed by time t₅ after 180 seconds elapsed since the time t₄. Then, at the time t₅, the UPS1 stops the power supply to the server 11. Then, the NMC1 of the UPS1 notifies the manager 110 in the management console 100 of the state change that represents the power supply stop by the TRAP of SNMP through the network apparatus 13 (step (11)). The manager 110 recognizes the power supply stop (output OFF) of the UPS1.

Furthermore, at time t₆ after 60 seconds elapsed since the time t₅, the UPS2 stops the power supply to the storage device 12. Then, the NMC2 of the UPS2 notifies the manager 110 in the management console 100 of the state change that represents the power supply stop by TRAP of SNMP through the network apparatus 13 (step (12)). The manager 110 recognizes the power-supply stop (output OFF) of the UPS2.

Furthermore, at time t₇ after 60 seconds elapsed since the time t₆, the UPS3 stops the power supply to the network apparatus 13. The NMC3 of the UPS3 tries to notify the state change that represents the power-supply stop of the UPS3, however, it is impossible to notify the state change because the network apparatus 13 stopped.

When such operations are performed, the stop of each apparatus is appropriately performed in appropriate order.

Moreover, because it is possible to grasp order that the UPS2 stops the power supply next to the UPS1 after the power failure occurred, on the management console 100 side, it is possible to determine whether or not this order is appropriate. Furthermore, the interval between the time t₄ and the time t₅ and the interval between the time t₅ and the time t₆ can be grasped on the management console 100 side, therefore, it is possible to determine whether or not the intervals are appropriate.

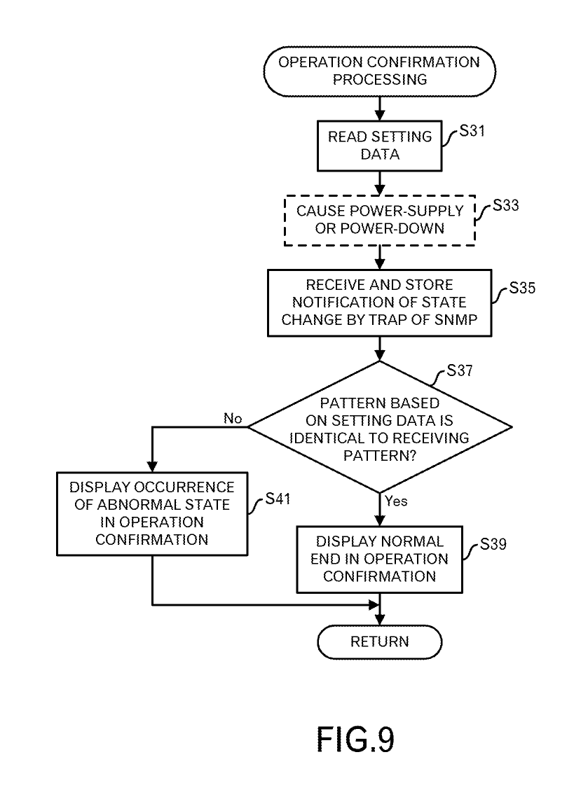

Next, the operation confirmation processing will be explained by using FIG. 9.

For example, when an operation confirmation instruction is accepted from the user, the determination unit 115 reads out the setting data from the data storage unit 120 (FIG. 9: step S31).

Moreover, the user starts the power feeding when the power feeding of the commercial power source 15 is currently stopped, or the user stops the power feeding when the power feeding is already started (step S33). This operation is the user's operation, therefore, it is depicted by a dotted block in FIG. 9.

Then, the receiver 114 of the manager 110 receives the notification of the state change by TRAP of SNMP from the NMC of the UPS, and stores the notification in the storage unit such as the main memory (step S35).

As explained by using FIG. 8, it becomes possible to identify the receiving order and receiving intervals of the notifications of the state changes.

Then, the determination unit 115 determines whether or not a pattern based on the setting data is identical to the receiving pattern (step S37). As explained by using FIG. 8, according to the setting data, a pattern is obtained that the power-supply start of the UPS2 and then the power-supply start of the UPS1 are performed at the power feeding, and the interval between them is 180 seconds. Then, at the step S37, when the actual receiving pattern of the notifications of the state changes represents this order, and the interval of the notification is about 180 seconds, it is determined that the actual receiving pattern is identical to the pattern based on the setting data, and when the order is different or the interval is different beyond a permissible range, it is determined that they are not identical.

Similarly, a pattern is obtained that the occurrence of the power failure, the power-supply stop of the UPS1 and the power-supply stop of the UPS2 were performed in this order at the power failure, and their intervals are 180 seconds and 60 seconds. Then, when the actual receiving pattern of the notifications of the state changes represents that order and the intervals of the notifications are about 180 seconds and 60 seconds, it is determined at the step S37 that the actual receiving pattern is identical to the pattern based on the setting data, and when the order is different or any interval is different beyond the permissible range, it is determined that they are not identical.

When it is determined that they are different, the determination unit 115 displays the occurrence of the abnormal state in the operation confirmation on the display screen of the display device 140 (step S41). For example, in addition to a message to the effect that the actual receiving pattern is different from that based on the setting data, auxiliary data that the order is different or the intervals are different may be displayed.

On the other hand, when it is determined that they are identical, the determination unit 115 displays a normal end in the operation confirmation on the display screen of the display device 140 (step S39). For example, a message to the effect that the system operated according to the setting data is displayed.

When the aforementioned operation confirmation processing is performed and it is determined that the operation is normal, the server and storage device are shut down appropriately when an actual power failure occurs and they are activated appropriately at the power feeding start.

On the other hand, when the occurrence of the abnormal state is confirmed, a cause of the abnormality is found by confirming the setting data and confirming the physical connections, and by performing the input of the setting data again and/or performing the physical connections again, the user prepares for the occurrence of the power failure.

As described above, by providing the manager 110 in the management console 100, it becomes possible to improve the efficiency of the setting processing for plural UPSs connected to plural connected apparatuses. Moreover, it is possible to perform the operation confirmation, and prepare the occurrence of the power failure.

### Embodiment 2

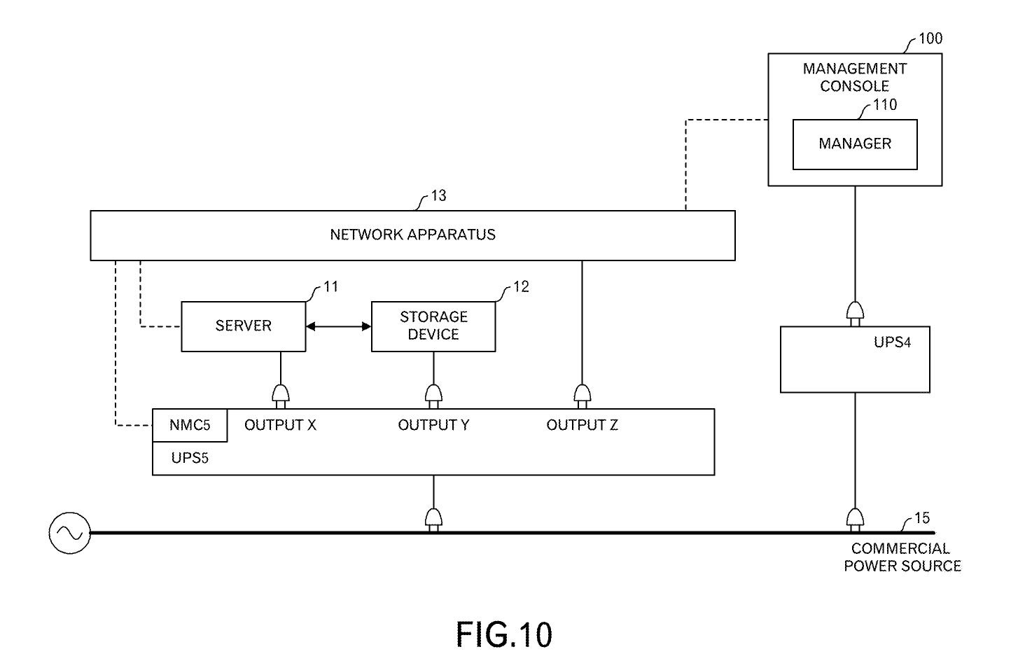

In the first embodiment, as depicted in FIG. 1, an example is illustrated that one apparatus is connected to each UPS. However, for example, as illustrated in FIG. 10, outputs X to Z are provided for UPS5, and the output X is connected with the server 11 by a power-supply cable, the output Y is connected with the storage device 12 by a power-supply cable, and the output Z is connected with the network apparatus 13 by a power-supply cable. As for the outputs X to Z, the power supply start and stop can be independently controlled. Plural outputs may be managed as one power feeding management group. The UPS5 has one NMC5, and is connected to the network apparatus 13 by a LAN cable.

Even in such a case, by performing the similar processing to the first embodiment, the efficiency of the inputs of the setting data can be improved.

However, the association between the UPS and the connected apparatus and the setting screen based on the association are changed. In other words, instead of each UPS, for each power feeding management group of the UPS, apparatuses are associated. In addition, there is only one NMC for the same UPS, therefore, the association for the NMC is also performed.

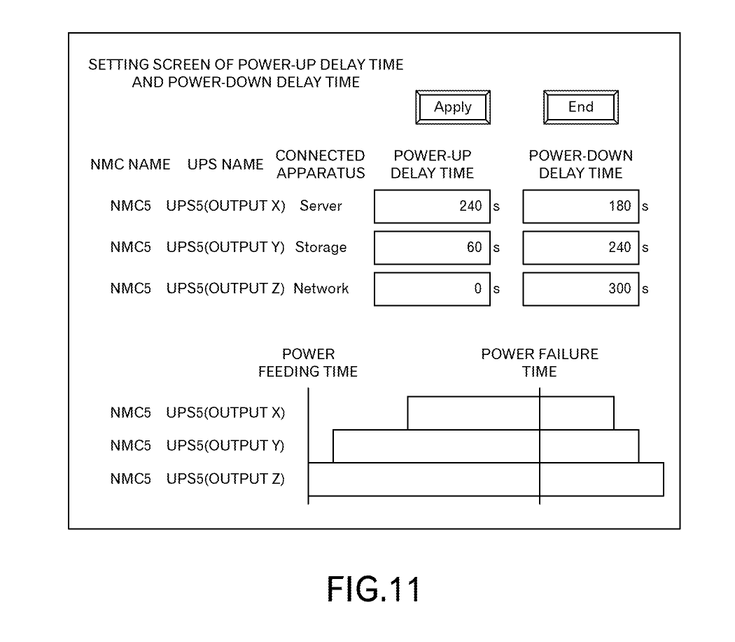

Furthermore, as for the setting screen, the setting screen as illustrated in FIG. 11 is displayed, for example. Thus, the NMC5 and the UPS5 (output X) are associated with the server 11, and for this association, input columns for the power-up delay time and the power-down delay time are provided. Similarly, the NMC5 and the UPS5 (output Y) are associated with the storage device 12, and for this association, input columns for the power-up delay time and the power-down delay time are provided. Furthermore, the NMC5 and the UPS5 (output Z) are associated with the network apparatus 13, and for this association, input columns for the power-up delay time and the power-down delay time are provided. As for the diagram provided in the lower stage of the setting screen, the display is different according to the associations. However, as for the numeric values to be inputted for the connected apparatuses, the same values are inputted when the same operation is performed.

The Set command of SNMP is transmitted to each UPS at the step S23 in the setting processing, however, in this example, the setting data for each of three outputs is transmitted to one UPS.

In addition, only one UPS transmits the notification of the state change by TRAP of SNMP at the step S35 in the confirmation processing. However, when it is possible to identify which output of the three outputs is related to the notification, the confirmation processing is performed similarly.

Thus, a case where there are plural outputs in one UPS can also be handled.

### Other Embodiments

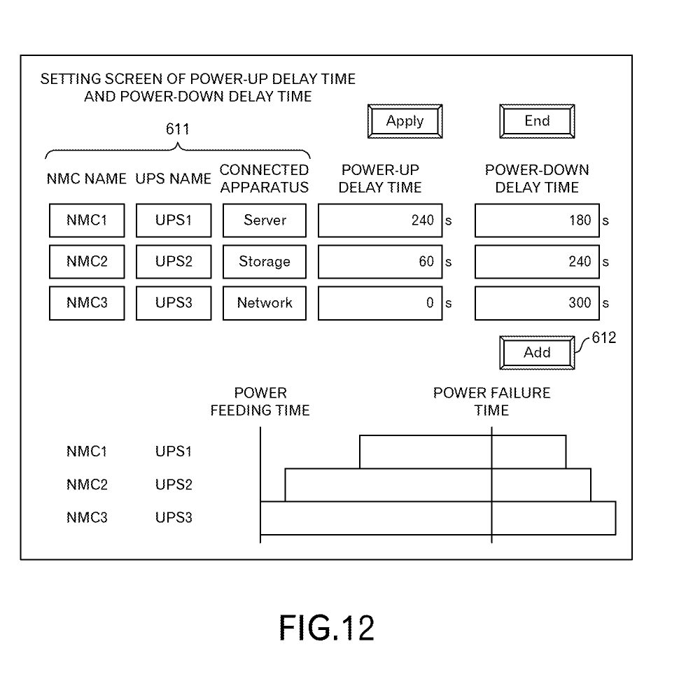

In the first embodiment, the association between the UPS and the connected apparatus is set in another screen, however, for example, as illustrated in FIG. 12, in the setting screen for the power-up delay time and the power-down delay time, the association between the UPS and the connected apparatus may be performed. In an example of FIG. 12, inputs columns 611 for also making the association with the NMC together are provided. The address of the NMC and the address of the connected apparatus may be set by a pop-up screen or the like, separately. Furthermore, in the example of FIG. 12, an Add button 612 is provided. Therefore, a line that includes input columns of the association between the UPS and the connected apparatus and input columns of the power-up delay time and the power-down delay time can be added. According to this, it becomes possible to handle a case where three or more associations have to be set.

Furthermore, in the example of the first embodiment, the power-up delay time and the power-down delay time are inputted on one screen, however, data for the power failure and data for the power feeding may be set separately.

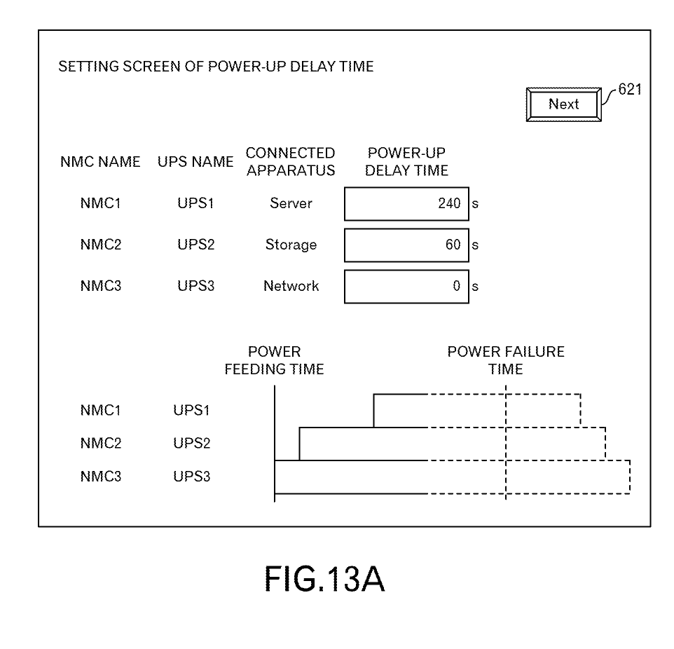

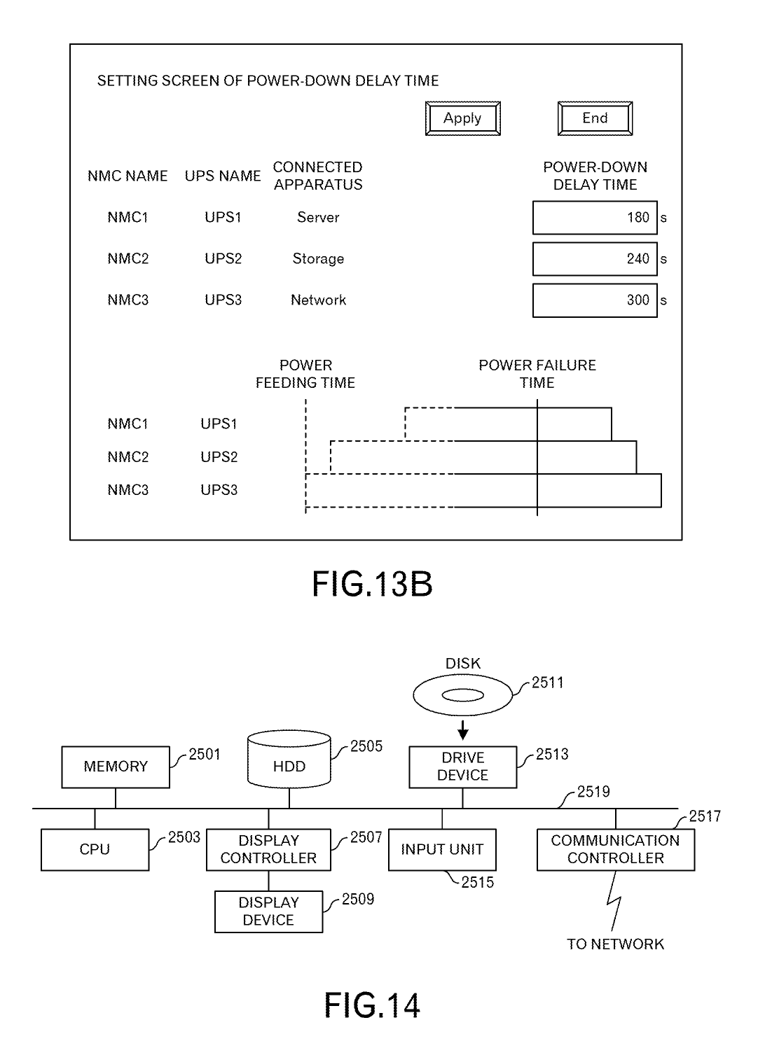

In other words, for example, as illustrated in FIGS. 13A and 13B, a setting screen to input the power-up delay time for each association between the UPS and the connected apparatus and a setting screen to input the power-down delay time for each association between the UPS and the connected apparatus are separated. When the setting screen as illustrated in FIG. 13A is precedently displayed, “Next” button 621 to shift to the next setting screen (FIG. 13B) is provided in FIG. 13A. Moreover, also as for the diagram for schematically displaying the setting data in the lower stage, only portions for the power-up delay time may be displayed by the solid lines in FIG. 13A, and portions for the power-down delay time may not be displayed. However, the portions for the power-down delay time may be displayed when there is previous setting data. Furthermore, in FIG. 13B, only the portions for the power-down delay time may be displayed by the solid lines, and the portions for the power-up delay time may not be displayed. However, contents set in FIG. 13A may be displayed.

Although the embodiments of this invention were explained above, this invention is not limited to those. For example, the functional block diagram of the management console 100 as illustrated in FIG. 3 is a mere example, and does not correspond to a program module configuration. In addition, as for the processing flow, as long as the processing result does not change, the turns of the steps may be exchanged, or plural steps may be executed in parallel.

Moreover, the configuration of the setting screen is a mere example, and any configuration may be adopted when the aforementioned points are reflected.

In addition, the aforementioned management console 100 is a computer device as depicted in FIG. 14. That is, a memory 2501 (storage device), a CPU 2503 (processor), a hard disk drive (HDD) 2505, a display controller 2507 connected to a display device 2509, a drive device 2513 for a removable disk 2511, an input unit 2515, and a communication controller 2517 for connection with a network are connected through a bus 2519 as depicted in FIG. 14. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application programs systematically cooperate with each other, so that various functions as described above in details are realized.

The aforementioned embodiments are outlined as follows:

An information processing method relating to the embodiments includes (A) performing, on a display device, display for requesting a user to collectively input, for each of plural apparatuses whose activation or stop is to be controlled, a first time for causing a power-supply start to be delayed since a power feeding start or a second time for causing a power-supply stop to be delayed since a power failure, by an uninterruptible power supply that supplies power to the apparatus among one or more uninterruptible power supplies or by a power feeding management group in the uninterruptible power supply; and (B) setting, for each of the plural apparatuses, the inputted first time or second time for the uninterruptible power supply that supplies power to the apparatus, via a communication network.

By collectively inputting, it is possible to input the first time or the second time while comparing and confirming them among plural apparatuses, and to avoid inconsistent setting.

In addition, the aforementioned performing may include displaying, on the display device, a diagram for comparing first times or second times inputted for the plural apparatuses. It becomes possible to intuitively confirm whether or not the first time or the second time is appropriate.

Furthermore, the aforementioned information processing method may further include: receiving, via the communication network, notification of a power-supply start or notification of a power-supply stop for any one of the plural apparatuses from the one or more uninterruptible power supplies; determining whether an order of notifications and an interval of the notifications are identical to an order of power-supply starts or power-supply stops and an interval of the power-supply starts or power-supply stops of at least two of the plural apparatuses, which are identified from first times or second times inputted for the plural apparatuses; and displaying a result of the determining on the display device. By doing so, it is possible to easily confirm whether or not connections between the apparatuses and the uninterruptible power supplies and the setting of the first time or the second time have any inconsistency.

Furthermore, the aforementioned performing may include requesting the user to designate, for each of the plural apparatuses, an uninterruptible power supply that supplies power to the apparatus among the one or more uninterruptible power supplies or a power feeding management group of the uninterruptible power supply. The user may make all of the associations, or by partially extracting and listing candidates through the communication network, the user may select the candidates to make the associations.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory such as ROM (Read Only Memory), and hard disk. In addition, the intermediate processing result is temporarily stored in a storage device such as a RAM or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An information processing apparatus, comprising:
a memory; and
a processor configured to use the memory and execute a process, the process comprising:
performing, on a display device, display for requesting a user to collectively input, for each of a plurality of apparatuses whose activation or stop is to be controlled, a first time for causing a power-supply start to be delayed since a power feeding start or a second time for causing a power-supply stop to be delayed since a power failure, by an uninterruptible power supply that supplies power to the apparatus among one or more uninterruptible power supplies or by a power feeding management group in the uninterruptible power supply; and
setting, for each of the plurality of apparatuses, the inputted first time or second time for the uninterruptible power supply that supplies power to the apparatus, via a communication network.

2. The information processing apparatus as set forth in claim 1, wherein the performing comprises displaying, on the display device, a diagram for comparing first times or second times inputted for the plurality of apparatuses.

3. The information processing apparatus as set forth in claim 1, wherein the process further comprises:
receiving, via the communication network, notification of a power-supply start or notification of a power-supply stop for any one of the plurality of apparatuses from the one or more uninterruptible power supplies;
determining whether order of notifications and an interval of the notifications are identical to order of power-supply starts or power-supply stops and an interval of the power-supply starts or power-supply stops of at least two of the plurality of apparatuses, which are identified from first times or second times inputted for the plurality of apparatuses; and
displaying a result of the determining on the display device.

4. The information processing apparatus as set forth in claim 1, wherein the process further comprises requesting the user to designate, for each of the plurality of apparatuses, an uninterruptible power supply that supplies power to the apparatus among the one or more uninterruptible power supplies or a power feeding management group of the uninterruptible power supply.

5. A computer-readable, non-transitory storage medium storing a program for causing a computer to execute a process, the process comprising:
performing, on a display device, display for requesting a user to collectively input, for each of a plurality of apparatuses whose activation or stop is to be controlled, a first time for causing a power-supply start to be delayed since a power feeding start or a second time for causing a power-supply stop to be delayed since a power failure, by an uninterruptible power supply that supplies power to the apparatus among one or more uninterruptible power supplies or by a power feeding management group in the uninterruptible power supply; and
setting, for each of the plurality of apparatuses, the inputted first time or second time for the uninterruptible power supply that supplies power to the apparatus, via a communication network.

6. An information processing method, comprising:
performing, by using a computer and on a display device, display for requesting a user to collectively input, for each of a plurality of apparatuses whose activation or stop is to be controlled, a first time for causing a power-supply start to be delayed since a power feeding start or a second time for causing a power-supply stop to be delayed since a power failure, by an uninterruptible power supply that supplies power to the apparatus among one or more uninterruptible power supplies or by a power feeding management group in the uninterruptible power supply; and
setting, by using the computer and for each of the plurality of apparatuses, the inputted first time or second time for the uninterruptible power supply that supplies power to the apparatus, via a communication network.
